(19) United States
(12) Patent Application Publication
(10) Pub. No.: US 2009/0171799 A1
(43) Pub. Date: Jul. 2, 2009

(54) WIRELESS POINT-OF-SALE TRANSACTION SYSTEM AND METHOD

(75) Inventor: Jeffrey Ying, Glendora, CA (US)

Correspondence Address: IRELL & MANELLA LLP, 1800 AVENUE OF THE STARS, SUITE 900, LOS ANGELES, CA, 90067, US

(73) Assignee: I/O CONTROLS CORPORATION, Azusa, CA (US)

(21) Appl. No.: 12/398,170

(22) Filed: Mar. 4, 2009

Related U.S. Application Data
(62) Division of application No. 10/772,100, filed on Feb. 4, 2004.

(51) Int. Cl. G06Q 30/00; G06Q 20/00; H04L 9/32

(52) U.S. Cl. 705/18; 705/20; 705/26

(57) ABSTRACT

A wireless consumer transaction system and method includes wireless equipment coupled to a point-of-sale system, whereby consumers are enabled to set up and carry out point-of-sale transactions in an automated or semi-automated manner using a wireless device. Users entering within the coverage area of the wireless equipment are prompted to conduct a point-of-sale transaction. The point-of-sale system transmits menu options to the user's wireless device. The user selects from the options provided, and is given the ability to purchase the desired goods or services in an automated manner using the wireless device. The wireless equipment of the point-of-sale system is preferably coupled to a point-of-sale computer, which is in turn coupled to a remote processing center. An automated purchase transaction may be conducted by obtaining approval and/or automatically withdrawing funds from the remote processing center in response to user-initiated activity.

### CROSS REFERENCE TO RELATED APPLICATIONS

This application is a divisional of copending U.S. application Ser. No. 10/772,100 filed Feb. 4, 2004, which is hereby incorporated by reference as if set forth fully herein.

### BACKGROUND OF THE INVENTION

1. Field of the Invention

The field of the present invention relates to wireless systems and methods for carrying out consumer transactions.

2. Background

Use of cellular telephones and other wireless devices has become extremely widespread. Such devices are, for example, capable of conveying voice or text information across cellular networks. More recently, consumer wireless devices such as cellular phones have been designed to also convey graphics, digital images, electronic mail, and/or multi-media messaging. Such devices include, for example, varieties of so-called 2.5G and 3G telephones. A variety of standards for 3G telephones have been promulgated in connection with the UMTS (Universal Mobile Telecommunications System). Despite the continued evolution of 2.5G and 3G technology, a large installed base of traditional (or “2G”) cellular telephone users still exists and will likely continue to exist for the foreseeable future.

Hereinafter, wireless telephones of all types (including 2G, 2.5G, or 3G/UMTS), as well as any other mobile devices having similar functionality, will be referred to generically under the term “cellular telephone.”

Touchtone telephones have been used in various settings to facilitate certain limited types of automated transactions. For example, consumers may use a touchtone telephone to contact remote automated telephone systems and to navigate various menu options for the purpose of, e.g., finding out information about a certain topic (airline schedules, weather, etc.), or handling certain personal transactions (for example, checking financial account information or transferring funds). These automated telephone transaction or information systems generally present information to the user by way of pre-recorded voice messages, and the user generally responds to the presented options either by selecting an entry on the telephone keypad or, in some cases, with voice commands that are interpreted by voice recognition technology at the remote system. Such activity may be carried out using either wireless or non-wireless telephones. However, among other things, conventional automated systems generally do not take account of the user's location in providing information to the user.

It would be advantageous to provide a system for facilitating consumer transactions which takes advantage of, among other things, the mobile nature of wireless telephones and/or other wireless communication devices.

### SUMMARY OF THE INVENTION

In one aspect, a wireless consumer transaction system and associated methods are provided whereby consumers are enabled to set up and carry out point-of-sale transactions in an automated or semi-automated manner, using a wireless device. In certain embodiments, wireless equipment associated with a point-of-sale system operates in parallel with a cellular network. Users entering within the coverage area of the wireless equipment are prompted to conduct a point-of-sale transaction. The point-of-sale system transmits menu options to the user's wireless device. The user selects from the options provided, and is given the ability to purchase the desired goods or services in an automated manner using the wireless device. An automated purchase transaction may be conducted, for example, via a remote processing center that is in electronic communication with the point-of-sale system.

Further embodiments, variations, modifications, and enhancement are also described herein within the detailed description and/or illustrated in the accompanying figures.

### BRIEF DESCRIPTION OF THE DRAWINGS

The present invention and its advantages may be better understood by reference to the drawings, wherein:

FIG. 1 is a block diagram of a wireless consumer transaction system in accordance with one embodiment as disclosed herein.

FIG. 2 is a block diagram illustrating further details of a wireless consumer transaction system in accordance with an exemplary embodiment as disclosed herein.

FIG. 3 is a block diagram of a wireless local area network as may be incorporated, for example, in the wireless consumer transaction system of FIG. 2 according to one embodiment as disclosed herein.

FIG. 4 is a diagram of an alternative embodiment in which a cellular base station acts as intermediary between a wireless communication device and a point-of-sale system.

FIG. 5 is a flow diagram illustrating an example of a process for an initial handshake between a wireless device and a local point-of-sale system.

FIG. 6 is a flow diagram illustrating an example of a process in accordance with one embodiment as may be carried out for a consumer transaction, from a user perspective.

FIG. 7 is a flow diagram illustrating an example of a process in accordance with one embodiment as may be carried out for a consumer transaction, from a system perspective.

FIG. 8 is a diagram illustrating an example of establishing initial communication between a wireless device and a local point-of-sale system in which a number of local point-of-sale systems are collocated.

FIG. 9 is a diagram illustrating an example of a wireless consumer transaction system as used in the context of a transit vehicle.

### DETAILED DESCRIPTION OF THE PREFERRED EMBODIMENT(S)

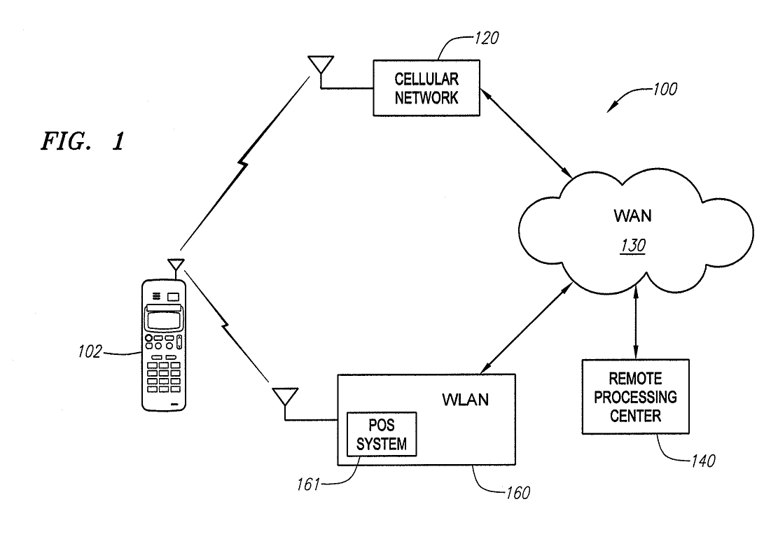

FIG. 1 is a block diagram of a wireless consumer transaction system 100 illustrating certain features and components relevant to various embodiments disclosed herein. As shown in FIG. 1, the wireless consumer transaction system 100 comprises a wireless local area network 160 including a point-of-sale system 161, that communicates with a remote processing center 140 over a distributed or wide-area network (WAN) 130 such as, for example, the Internet, although alternatively the communication may take place using a dedicated connection or other means. In the embodiment shown, a wireless handheld device 102, such as, for example, a cellular telephone, may communicate with either a cellular telephone network 120 or the wireless local area network 160, as further described herein. The wireless handheld device 102 is preferably also capable of communicating information to the remote processing center 140, via the cellular network 120.

In a preferred embodiment, the wireless consumer transaction system 100 is configured so as to facilitate point-of-sale transactions carried out at a point-of-sale system 161 which forms part of the wireless local area network 160. The wireless local area network 160 preferably comprises wireless equipment or other means for detecting the presence of the wireless handheld device 102 within the range of the wireless local area network 160, according to techniques as will be hereinafter described. The wireless local area network 160 may then engage in a handshake type transaction with the wireless handheld device 102, a result of which is to provide a menu of options for a consumer transaction for presentation on a display portion of the wireless handheld device 102. As part of the handshake transaction, the wireless local area network 160 may obtain certain identifying or other information from the wireless handheld device 102, and then communicate with the remote processing center 140 in order to validate the wireless handheld device 102 and/or user thereof.

Assuming that the wireless handheld device 102 and/or user is validated, the wireless local area network 160 facilitates a point-of-sale transaction with the user of the wireless handheld device 102. The user may navigate through various menus or sub-menus transmitted from the wireless local area network 160 to the wireless handheld device 102. The menus or sub-menus may be customized for the particular point-of-sale system 161, and may present the user with various options for review and/or purchase. The user may make various selections via the wireless handheld device 102, which are conveyed to the point-of-sale system 161 through the wireless connection established with the wireless local area network 160. Eventually, the user is ready for purchase, and may engage in a purchase transaction at the point-of-sale system 161. The purchase may be conducted in any of a variety of manners. For example, the purchase may be conducted as a traditional monetary transaction using hard currency, or else may be conducted electronically by drawing upon a user account managed at least in part by the remote processing center 140.

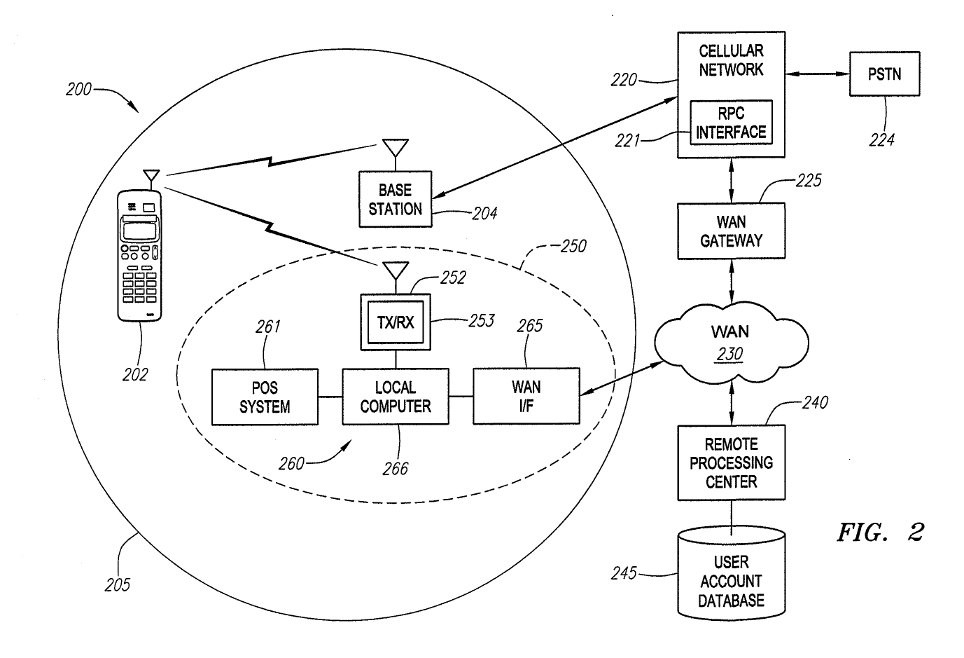

Further details of a preferred embodiment in general accordance with the principles illustrated in FIG. 1 will now be described. In particular, FIG. 2 is a block diagram illustrating details of a wireless consumer transaction system 200 in accordance with an exemplary embodiment as disclosed herein. As illustrated in FIG. 2, the wireless consumer transaction system 200 involves a base station 204 which is part of or connected to a cellular network 220. The base station 204 and cellular network 220 may, for example, generally be of any conventional design and configuration, although the cellular network 220 preferably additionally includes a remote processing center interface 221 as further detailed herein. The base station 204 is thus configured to communicate with various wireless devices as may be present within its cell 205, i.e., the geographical region of its coverage.

As one example, the cellular network with which the base station 204 is associated may be a GSM network. A portion of the wireless infrastructure provided by the base station 204 and other cellular equipment may constitute part of the UMTS terrestrial radio access network (UTRAN), and gateway and routing may be provided as part of the UMTS core network.

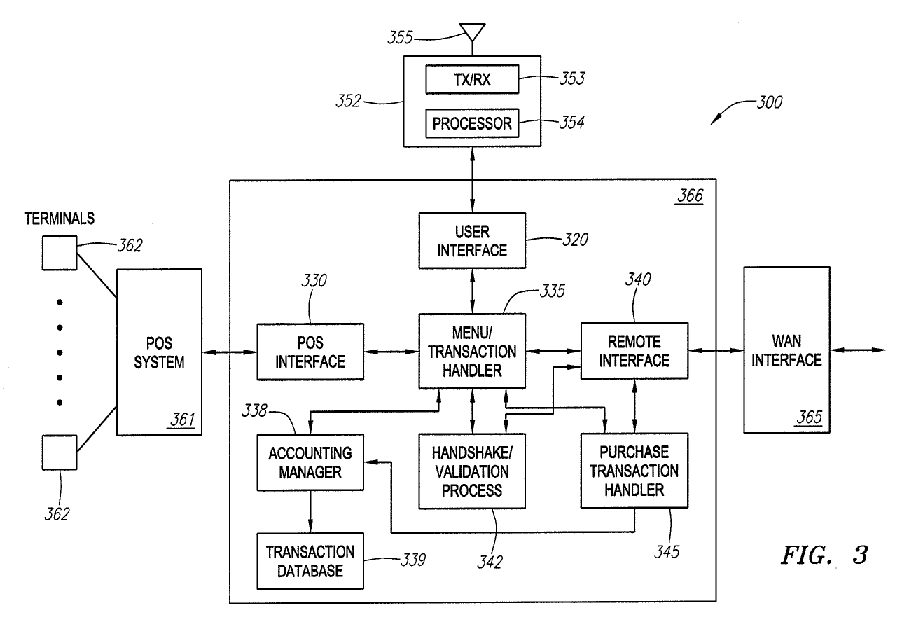

The wireless consumer transaction system 200 further comprises a wireless local area network 260 including a local wireless station 252 having a limited coverage area 250 generally much smaller than cell 205. For convenience, to distinguish it from cell 205, the coverage area 250 of the local wireless station 252 will be referred to as a microcell. The local wireless station 252 comprises wireless equipment 253 preferably including a transceiver capable of communicating with multiple users of wireless handheld devices 202 within the microcell 250. The local wireless station 252 may be coupled to a local computer 266 which, in turn, is communicatively coupled to a point-of-sale (POS) system 261 (which may include, e.g., one or more point-of-sale terminals). Similar to the embodiment described in FIG. 1, the local computer 266 is preferably adapted to communicate with a remote processing center 240 over a distributed or wide-area network (WAN) 230 such as, for example, the Internet, although alternatively the communication may take place using a dedicated connection or other means. A WAN interface 265 (or other interface, depending upon the connection type) may be used to facilitate communication between the local computer 266 and the WAN 230. Further details of a preferred wireless local area network 260 are illustrated, for example, in FIG. 3.

The cellular network 220 will typically connect to a public switched telephone network (PSTN) 224 for connecting calls (whether voice or data) from wireless handheld devices 102 to various desired endpoints. The cellular network 220 preferably is configured to communicate over the WAN 230, or otherwise (e.g., a dedicated connection), to the remote processing center 240, via, e.g., a gateway 225 (which, if the WAN 230 comprises the Internet, may comprise an Internet gateway 225). The cellular network 220 may include a remote processing center interface 221 for handling communication with the remote processing center 240 over the WAN 230.

A wireless handheld device 202, such as, for example, a cellular telephone, preferably may communicate with either a cellular telephone network 220 (via base station 204 or other base stations, not shown) or the wireless local area network 260, as further described herein. The wireless handheld device 202 is preferably also capable of communicating information to the remote processing center 240, via the cellular network 220. Although the embodiment of FIG. 2 may occasionally be further described according to the specific example wherein the wireless handheld device 202 is a cellular telephone, it should be understood that other wireless devices may also be used in place of a cellular telephone.

In a preferred embodiment, as generally described with respect to FIG. 1, the wireless consumer transaction system 200 of FIG. 2 is configured so as to facilitate point-of-sale transactions carried out at the point-of-sale system 261 which forms part of the wireless local area network 260. The wireless equipment 253 of the wireless local area network 260 is preferably configured to detect the presence of a wireless handheld device 202 within the area of coverage (microcell) 250 of the wireless local area network 260 in any of a variety of manners. The wireless local area network 260 may then engage in a handshake type transaction with the wireless handheld device 202, the ultimate result of which is to provide a menu of options for a consumer transaction for presentation on a display portion of the wireless handheld device 202. As part of the handshake transaction, the wireless local area network 260 may obtain certain identifying or other information from the wireless handheld device 202, and then communicate with the remote processing center 240 in order to validate the wireless handheld device 202 and/or user thereof.

Particular examples of the initial handshake process, and other processes, will be described with respect to FIG. 3, which is a block diagram of a wireless local area network 300 (which may be incorporated in FIG. 2, for example, as wireless local area network 260) according to one embodiment as disclosed herein. The wireless local area network 300 illustrated in FIG. 3 comprises a local wireless station 352 having wireless equipment 353 for communicating with various wireless handheld devices such as, e.g., cellular telephones and the like. The local wireless station 352 further includes a processor 354 for interfacing with the wireless equipment 353 and a local computer 366. The local computer 366 is communicatively coupled to a point-of-sale system 361 and to a WAN interface 365 (or other communication interface for communicating with the remote processing center 240).

The local computer 366 is programmed with a variety of applications, including a user interface 320 for communicating with the wireless handheld devices 202 (see FIG. 2) via the wireless station 352, a point-of-sale interface 330 for communicating with the point-of-sale system 361, and a remote interface 340 for communicating with the remote processing center 240 (see FIG. 2). The local computer 366 is further programmed with a menu/transaction handler 335, which manages various wireless point-of-sale transactions. In the particular example illustrated in FIG. 3, the menu/transaction handler 335 may invoke various other applications or processes including a handshake/validation process 342, a purchase transaction handler 345, and an accounting manager 338. The local computer 366 may also optionally, depending upon the nature of the system, have a cellular network interface 380.

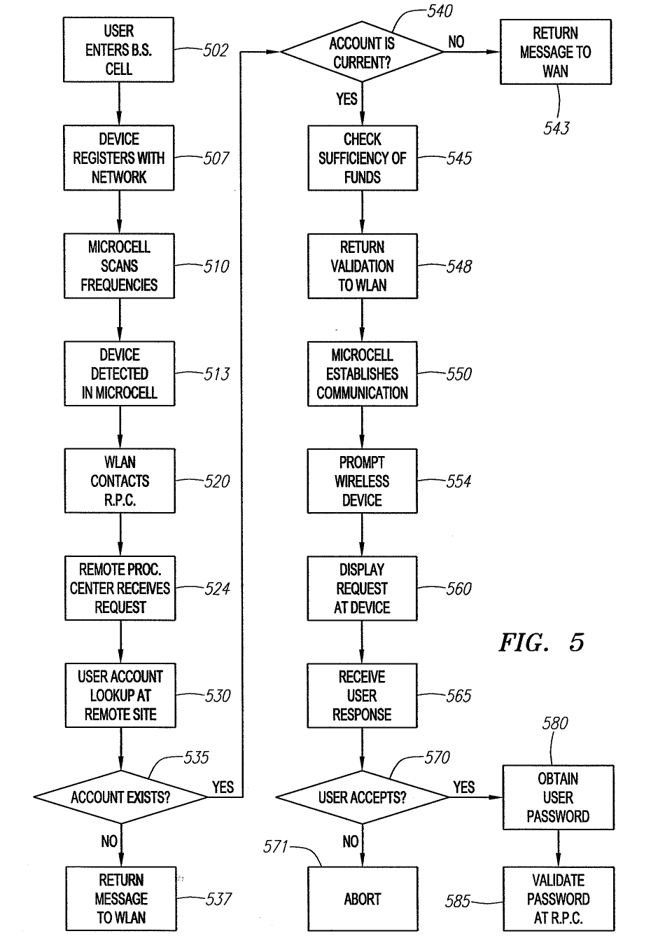

Further details of examples of an initial handshake transaction will now be described, with particular reference to steps set forth in FIG. 5, as well as the exemplary system 200 illustrated in FIG. 2 and exemplary wireless local area network 300 illustrated in FIG. 3. According to the example of a handshake process 500 illustrated in FIG. 5, in a first step 502 the wireless handheld device 202 enters the cell 205 serviced by base station 204, or else is activated while in the cell 205. Either of these events will typically, depending upon the cellular network 220, cause the wireless handheld device 202 to register with the cellular network 220 (step 507). As indicated by step 510, the wireless station 252 (or 352) of the wireless local area network 260 (or 360) continuously scans the same frequencies and channels as used by the base station 204 of the cellular network 220. The wireless station 252 (or 352) may, for example, be programmed or configured when initially set up with knowledge of the frequencies and channels used by the base station 204. Alternatively, or in addition, where the local computer 366 includes a cellular network interface 380, the cellular network 220 may download information concerning the base station frequencies and channels to the local computer 366, which then conveys the information as a set of configuration parameters to the wireless station 352.

In step 513, the wireless handheld device 202 enters the range of microcell 250 and is detected by the wireless equipment 253 (or 353) of the wireless station 252 (or 352). For example, the wireless equipment 253 (or 353) may detect periodic re-registration or other sporadic communications between the wireless handheld device 202 and the base station 204. Alternatively, the cellular network 220 may be configured to notify the wireless local area network 260 that the particular wireless handheld device 202 is within cell 205, and the wireless equipment 252 (or 352) of the wireless local area network 260 (or 360) may attempt to page the wireless handheld device 202 periodically should the wireless handheld device 202 come within range (i.e., within microcell 250). The base station 204 may notify the wireless handheld device 202 to listen to a particular paging frequency or channel utilized by the wireless equipment 253 (or 353) of the wireless local area networks 260 (or 360), or else, for example, the wireless equipment 253 (or 353) may communicate with the wireless handheld device 202 using the base station 204 as an intermediary.

Thereafter, the wireless local area network 260 (or 360) conducts a back-end transaction with the remote processing center 240, in order to validate the wireless handheld device 202 and/or user. To this end, the menu/transaction handler 335 executing on the local computer 366 may, for example, invoke the handshake/validation routine 342, which in turn transmits a validation request to the remote processing center 240 via the remote interface 340. The validation request is preferably based upon the cellular telephone number assigned to the wireless handheld device 202. The telephone number is generally detectable by the wireless equipment 253 (or 353) monitoring communications with the base station 204.

In step 524, the remote processing center 240 receives the validation request and, in step 530, conducts a lookup in a user account database 245 to determine whether a user account is associated with the cellular telephone number conveyed by the wireless local area network 260 (or 360) to the remote processing center 240. If an account does not exist, a response to that effect is transmitted back to the wireless local area network 260 (or 360), which then may do nothing further with respect to the particular wireless handheld device 202. However, in alternative embodiments, the wireless local area network 260 (or 360) may nonetheless attempt to establish communication with the wireless handheld device 202 for the purpose of, e.g., conveying menu options and other such information to the user.

If the user has an account, then, in step 540, the remote processing center 240 may lookup the status in the user account database 245 to determine whether or not the account is current. In addition, the remote processing center 240 may be requested by the wireless local area network 260 (or 360) to determine in advance whether the account is sufficiently funded to carry out a point-of-sale transaction (step 545). The wireless local area network 260 (or 360) may transmit a monetary threshold amount to the remote processing center 240 to utilize for this purpose. Alternatively, the wireless local area network 260 (or 360) may wait until after a point-of-sale transaction is requested by the user prior to determining whether the account is sufficiently funded for the contemplated point-of-sale transaction.

In a next step 550, the wireless equipment 253 (or 353) of the wireless station 252 (or 352) attempts to establish communication with the wireless handheld device 202 by, for example, emulating a base station control channel and/or overpowering the base station transmissions within the limited confines of the microcell 250 for the particular channels and/or frequencies utilized by the wireless handheld device 202. Alternatively, the wireless local area network 260 (or 360) may be configured to transmit a message to the cellular network 220, via the cellular network interface 380, requesting that the base station 204 issue a page to the wireless handheld device 202 assigning it a particular channel and/or frequency band utilized by the wireless equipment 252 (or 352) of the wireless station 252 (or 352), for facilitating the establishment of communication between the wireless handheld device 202 and the wireless local area network 260 (or 360).

Once initial communication is established, as indicated in step 554, the wireless handheld device 202 is prompted automatically by the wireless local area network 260 (or 360). The wireless station 252 (or 352) initiates a point-to-point call or communication session with the wireless handheld device. Assuming the call is accepted (i.e., answered) by the user, the menu/transaction handler 335 transmits presentation information, preferably in the form of text and/or graphics (although alternatively, or in addition, audio information) to the wireless handheld device 202 for presentation thereon. The user is informed of, e.g., the nature of the request and the identity of the proprietor of the point-of-sale system 261. As indicated by step 560, the user is requested to accept or decline the commencement of a point-of-sale transaction. The user may make the appropriate selection (e.g., “Y” or “N”) using, for example, keypad entries on a cellular telephone, or other interface means, depending upon the nature of the wireless handheld device 202. In step 570, the user's selection is received by the wireless local area network 260 (or 360). If the user has accepted the call from the wireless local area network 260 (or 360), then the menu/transaction handler 335 may request a user password or ID for further validation, as indicated by step 580, or else such a step may be carried out at a later point.

Assuming that the wireless handheld device 202 and/or user is validated, communication is established with the wireless handheld device 202, and the user has assented to going forward, the wireless local area network 260 (or 360) then may facilitate a point-of-sale transaction with the user of the wireless handheld device 202. The user may, for example, be permitted to navigate through various menus or sub-menus transmitted from the wireless local area network 260 (or 360) to the wireless handheld device 202. The menus or sub-menus may be customized for the particular point-of-sale system 261 (or 361), and may present the user with various options for review and/or purchase. The user may make various selections via the wireless handheld device 202, which are conveyed to the point-of-sale system 261 (or 361) through the wireless connection established with the wireless local area network 260 (or 360). Eventually, the user is ready for purchase, and may engage in a purchase transaction at the point-of-sale system 261 (or 361).

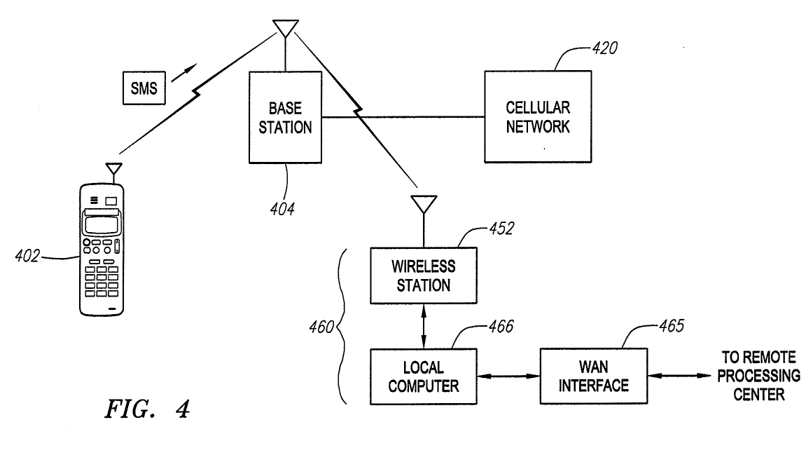

FIG. 4 is a diagram of an embodiment in which a cellular base station 404 acts as intermediary between a wireless communication device 402 and a point-of-sale system. As illustrated in FIG. 4, a point-of-sale system 460 includes a wireless station or equipment 452 coupled to a local computer 466, which in turn is configured to, among other things, communicate with a remote processing center (as described with respect to FIG. 2) via a remote or WAN interface 465. When a user with a wireless handheld device 402 enters the range of the wireless station 452, initial communication may be established between the wireless station 452 and the wireless handheld device 402. For example, the wireless station 452 may detect the presence of the wireless handheld device 402 as previously described, or may be notified of its presence within the general cellular region by the cellular network 420. In response to the presence of the wireless handheld device 402 coming within its range, the wireless station 452 may transmit a short (e.g., paging) message via the base station 404 to the wireless handheld device 402. For example, if the cellular system uses GSM, then the wireless station 452 may transmit an SMS (Short Message Service) type message, which provides approximately 160 characters for transmission.

The short message may contain information inviting the user to initiate a point-of-sale transaction. As one example, the short message may identify the point-of-sale establishment, its location, and prompt the user to see whether the user desires to initiate a point-of-sale transaction. Alternatively, the location information may be conveyed at a later time. The user may make an appropriate selection (e.g., “Y” or “N”) which will cause the wireless handheld device 402 to reply with, for example, another short message conveyed via the base station 404 to the wireless station 452. The wireless station 452 and wireless handheld device 402 may thereafter continue to communicate using short messages. Alternatively, the wireless handheld device 402 or the wireless station 452 may initiate a mobile-to-mobile call within the cell of the base station 404. The wireless station 452 may detect the number of the wireless handheld device 402 by listening to periodic re-registration or other sporadic communications by the wireless handheld device 402, and/or may convey an access telephone number to the wireless handheld device 402 through a short message delivered via the base station 404.

Besides the foregoing techniques for establishing communication, there are also other variations and techniques that may be used, any of which may incorporate to different degrees the techniques described above. Additional programming may be needed in some cases to support the added functionality of the user's wireless handheld device 402. In other cases, the wireless handheld device 402 may function effectively as a dumb terminal, relying on functionality already built in to it. The wireless station 452 may also be configured so as to be able to communicate according to several different cellular protocols, so as to be able to communicate with as many different types of wireless handheld devices 402 as possible.

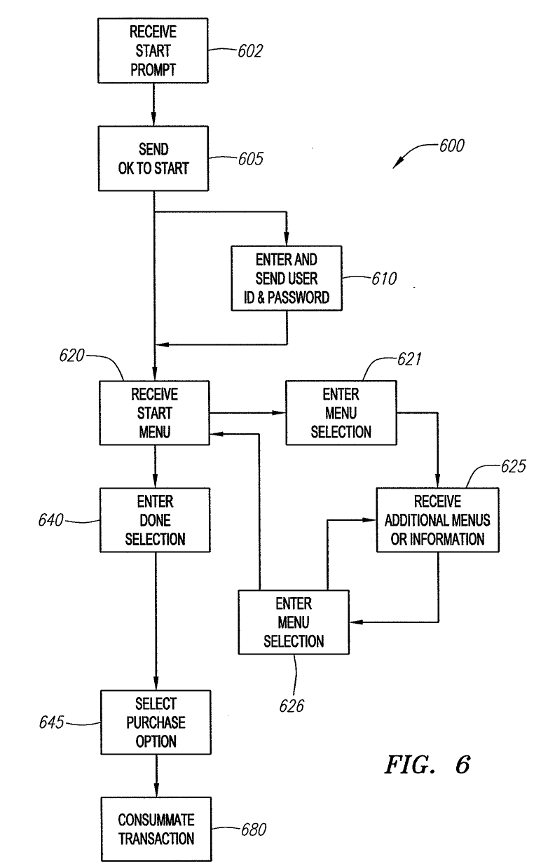

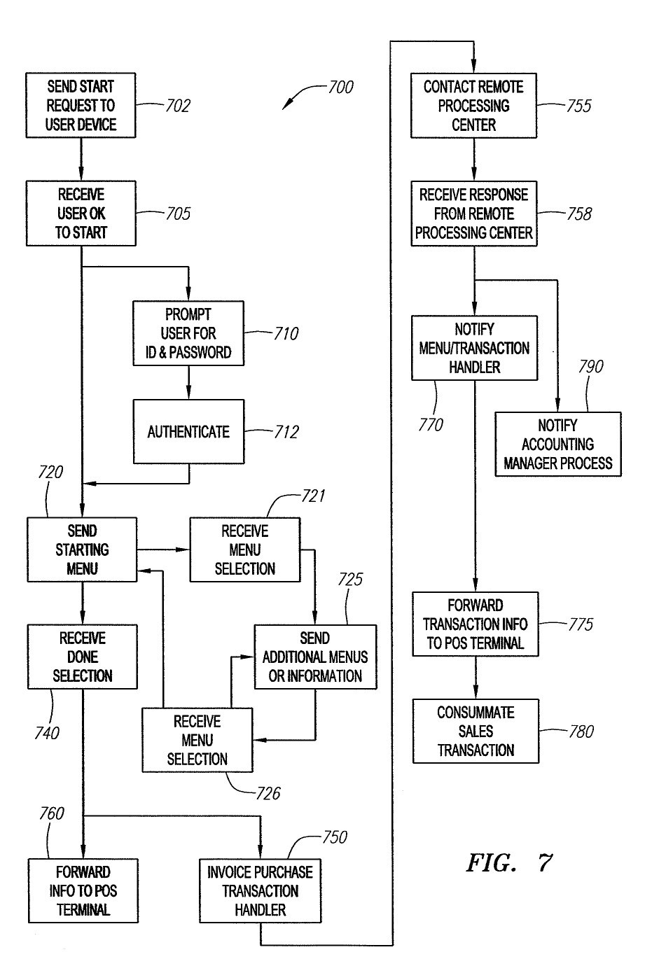

FIGS. 6 and 7 illustrate examples of a purchase transaction from user perspective and a system perspective, respectively. In FIG. 6, for example, an example of a purchase transaction process 600 from a user perspective is illustrated. The purchase transaction process 600 assumes that communication has already been established between the wireless handheld device 202 and the wireless local area network 260 (or 360). For purposes of illustration, the process flow diagrams of FIGS. 6 and 7 will be explained with reference to the wireless local area network 300 shown in FIG. 3; however, it should be understood that the processes of FIGS. 6 and 7 may be utilized in whole or part with respect to other physical or functional arrangements of a wireless consumer transaction system.

Turning first to FIG. 6, in a first step 602 of the illustrated user transaction process 600, and generally as previously described with respect to FIG. 5, the user's wireless handheld device 202 receives a request to initiate a purchase transaction or, more generally, to receive additional information from which a purchase transaction may be conducted. The information received by the wireless handheld device 202 preferably informs the user of, e.g., the nature of the request and the identity of the proprietor of the point-of-sale system 261. In step 605, the user replies with either an indication of a desire to proceed or not proceed. Assuming the user desires to proceed, then, as indicated by step 610, the user may be asked to provide a password and/or ID. If so, then in step 612, the user provides such information, and waits to be authenticated (although further portions of the transaction may be carried out, so long as a purchase is not consummated until the user is validated).

After the optional authentication step, and as indicated by step 620, the user's wireless handheld device 202 receives presentation information in the form of, e.g., text and/or graphics (and possibly in conjunction with audio information) from the menu/transaction handler 335 of the wireless local area network 360. For example, the user's wireless handheld device 202 may receive a start menu (in text and/or graphics, and optionally with audio information also) that provides various options. The user may be permitted to navigate through the start menu and, if provided, various other menus or sub-menus, making selections for additional menus or sub-menus and/or for items to be purchased, as generally indicated by steps 621, 625, and 626. The menus or sub-menus may be customized for the particular point-of-sale system 261 (or 361), and may present the user with various options for review and/or purchase. The user may make various selections via the wireless handheld device 202, which are conveyed to the point-of-sale system 261 (or 361) through the wireless connection established with the wireless local area network 260 (or 360). The wireless local area network 260 (or 360) responds to the user selections, either providing additional menu or sub-menu information, or else initiating a purchase transaction if applicable.

When the user desires to purchase an item, the user may select a suitable entry (by button, voice activation, or other means) on the menu or sub-menu using the interface (buttons, voice commands, or other means) of the wireless handheld device 240. The user's selection is conveyed over the wireless connection to the menu/transaction handler 335. When the user has selected all desired items, the user makes a suitable entry selection using the wireless handheld device 202, which is conveyed to the menu/transaction handler 335 of the wireless local area network 260, as indicated by step 640. The user may also indicate, by appropriate selection of options on the wireless handheld device 202, whether he or she wishes to engage in an automated purchase transaction using the user's remote account, or else to engage in a conventional purchase transaction.

If an automated purchase will be carried out, the wireless local area network 260 (or 360) completes the transaction and forwards an indication of approval or disapproval to the POS terminal 362. Once the transaction is approved, or alternatively after the user makes a conventional purchase, the user may be presented with the desired goods or items, and/or the transaction is otherwise consummated (step 680). If the user has indicated that he or she desires to use the remote account for purchase, the user may be asked to enter validation information (e.g., ID and/or password) if not previously provided. In any event, the user may be presented with a transaction number from the wireless local area network 260, via the wireless handheld device 202, so that the user can notify the point-of-sale clerk(s) of the appropriate transaction thereby allowing the transaction to be filled.

If the transaction has not been approved for whatever reason by the remote processing center 240, or if the user desires to make a purchase using conventional means (e.g., cash or credit from an account other than with the remote processing center 240), then the POS terminal 362 should already have all of the specifics of the user's desired purchase, including the final purchase amount. Thus, this overall process may save significant time for both customers and retail clerks, and reduces the likelihood of human error in price calculations.

Turning now to FIG. 7, a user transaction is illustrated more from the perspective of the automated system. In a first step 702 of the illustrated user transaction process 700, and generally as previously described with respect to FIGS. 5 and 6, the menu/transaction handler 335 transmits presentation information, preferably in the form of text and/or graphics (although alternatively, or in addition, audio information) to the user's wireless handheld device 202 for presentation thereon. The information supplied by the menu/transaction handler 335 preferably informs the user of, e.g., the nature of the request and the identity of the proprietor of the point-of-sale system 261. As indicated by step 705, the wireless local area network 260 (or 360) receives the user's selection (e.g., “Y” or “N”) indicating whether the user desires to commence a point-of-sale transaction. If the user has accepted the request from the wireless local area network 260 (or 360), then the menu/transaction handler 335 may transmit a request to the user's wireless handheld device 202 for a user password and/or ID for further validation, as indicated by step 710, or else such a step may be carried out at a later point. When the wireless local area network 260 (or 360) receives the user's password and/or ID, it conducts an authentication transaction (step 712) with the remote processing center 240 to ensure that the password and/or ID are valid. The wireless local area network 260 may also use, e.g., the mobile equipment identification number, if available, of the wireless handheld device 202 for authentication purposes. The mobile equipment identification number and/or user password or ID may be conveyed to the remote processing center 240 in connection with the authentication or validation transaction.

Assuming that the wireless handheld device 202 and/or user is validated, the wireless local area network 260 (or 360) then transmits a start menu (in text and/or graphics, and optionally with audio information also) to the user's wireless handheld device 202, as indicated by step 720, in order to facilitate a point-of-sale transaction. The user may be permitted to navigate through the start menu and, if provided, various other menus or sub-menus transmitted from the wireless local area network 260 (or 360) to the wireless handheld device 202, as generally indicated by step 725. The menus or sub-menus may be customized for the particular point-of-sale system 261 (or 361), and may present the user with various options for review and/or purchase. The user may make various selections via the wireless handheld device 202, which are conveyed to the point-of-sale system 261 (or 361) through the wireless connection established with the wireless local area network 260 (or 360), as indicated by step 730. The wireless local area network 260 (or 360) responds to the user selections, either providing additional menu or sub-menu information, or else initiating a purchase transaction if applicable.

When the user desires to purchase an item, the user may select a suitable entry (by button, voice activation, or other means) on the menu or sub-menu. The user's selection is conveyed over the wireless connection to the menu/transaction handler 335, as indicated by step 740. The menu/transaction handler 335 maintains the status of the transaction for each individual user. As the user selects items for purchase, the menu/transaction handler 335 associates those items with the particular user's session. When the user has selected all desired items, the menu/transaction handler 335 receives an indication from the user, via the wireless handheld device 202, that the user has completed all selections.

When the user is ready for purchase, he or she may engage in a purchase transaction at the point-of-sale system 261 (or 361). Assuming that an automated purchase will be carried out, the menu/transaction handler 335 preferably invokes the purchase transaction handler 345 to handle the automated transaction, as indicated by step 750. The user will have responded to the menus or sub-menus with a selection of one or more items for purchase. The items for purchase associated with the user's session are forwarded to the purchase transaction handler 345, which calculates the price (along with any additions such as tax, service fee, etc.) to be charged for the user. If the user has indicated that he or she desires to use the remote account for purchase, then, as indicated by step 755, the purchase transaction handler 345 processes the transaction with the remote processing center 240 by communicating via the remote interface 340. The purchase transaction handler 345 eventually receives an acceptance or denial of the transaction, as indicated by step 758. Simultaneously, the menu/transaction handler 345 may forward the details of the transaction to a local POS terminal 362 (as indicated by step 760), to allow employees of the establishment to prepare the user's order. For example, if the purchase is of fast food or beverages (e.g., coffee), the preparers may view the user's order on a POS display screen and start with preparation. If a retail store, the clerks may retrieve the items from stock to have them ready for the user. Alternatively, the menu/transaction handler 345 may wait until the purchase is approved before forwarding the information.

In the illustrated embodiment, the purchase transaction handler 345 preferably returns the calculated price information to the menu/transaction handler 335, as indicated by step 770, along with an indication of whether the transaction purchase has been completed or not. The menu/transaction handler 335 forwards the information to the POS interface 330 and the POS system 361, as indicated by step 775. The POS system 361 forward the information to one or more of the POS terminals 362. The retail clerk then fills the user's request by providing the desired goods—e.g., food or beverage, or other retail goods. If the transaction has not been approved by the remote processing center 240, or if the user desires to make a purchase using conventional means (e.g., cash or credit from an account other than with the remote processing center 240), then the POS terminal 362 already has all of the specifics of the user's desired purchase, including, if provided form the purchase transaction handler 345, the final amount. This information facilitates the clerk's role in finalizing the purchase transaction.

If the transaction is completed using the user's remote account, then, as indicated by step 790, the purchase transaction handler 345 notifies the accounting manager 338, which maintains a record of all transactions.

The foregoing processes may be illustrated with reference to a particular example where the automated system is associated with a fast food enterprise, and the user is a prospective customer thereof. When the user enters the range of microcell 250, the user's wireless handheld device 202 is prompted (e.g., paged) according, for example, to any of the techniques previously described herein. The user's wireless handheld device 202 may receive a brief message indicating the nature of the establishment, and the contents of the message may be displayed for the user. The user may then decide to accept or decline the invitation to proceed with a potential transaction. The user selects the appropriate entry (e.g., by pressing the appropriate button, making a voice command, etc.), which is conveyed back to the wireless automated system (i.e., wireless local area network 260) at the establishment. The user's wireless handheld device 202 may be programmed to be responsive to a portion of the received message in order to facilitate handshaking, and/or a local base station 404 may recognize the reply from the user's wireless handheld device 202 and route it to the wireless local area network 260.

If the user declines the invitation to proceed, the wireless local are network 260 stores the response along with the user's wireless telephone number (or any other available identifying information) and avoids sending another message to the user for a period of time. For example, the wireless local area network 260 may use a programmable backoff period (e.g., 20 minutes, an hour, etc.) during which it will not initiate communication with the same user.

Assuming the user desires to proceed and provides an appropriate response to the prompt from the wireless local area network 260, the wireless local area network 260 receives the user's response and may, if so configured, request user identification and/or a password. The user's wireless handheld device 202 may also be configured to transmit a hardwired identification number for the device, such as a mobile equipment identification number, which may also be used for verification and authentication. The wireless local area network 260 may conduct verification and authentication straightaway, or else may wait until the transaction is further along, in case the transaction gets aborted for any reason.

Once communication has been established and the user has indicated a desire to proceed, and authentication and validation have been carried out if desired, the wireless local area network 260 may transmit a starting menu to the user's handheld device 202. Carrying through with the example of a fast food enterprise, the starting menu may include various numbered options such as, for example, specific food categories (e.g., burgers, drinks, side orders, combination meals, etc.) depending upon the specific nature of the fast food enterprise. The user may then make selections using the standard interface of the wireless handheld device 202. The selections are preferably conveyed back to the wireless local area network 260 either directly (if a direct communication link has been established) or through an intermediary such as base station 204. The wireless local area network 260 reacts to the user's selections by storing them for use in the transaction and providing additional sub-menus if appropriate. For example, continuing with the present example, if the user selects “side orders” the wireless local area network 260 may respond by transmitting a sub-menu with a list of further options including, e.g., french fries, onion rings, salad, chips, etc. The user may then select from the newly presented items, making as many selections as desired. When all desired selections have been made from a sub-menu, the user may utilize a predefined command to back up to a higher level menu. The user may utilize another predefined command to indicate that the order is complete.

The particulars of the menu interface may be implemented in a variety of manners, and may provide additional sophistication if desired. For example, the user may be permitted to enter a first command (or numerical value) corresponding to a selection, followed by an additional command (which may include multiple button touches or sub-commands) that may be used to select quantity. The user is also preferably permitted to use a predefined command to delete existing selections. The wireless local area network 260 may transmit the final order to the user's wireless handheld device 202 for display once the user has indicated that the selections are complete, and/or the user may be provided with a predefined command to list or repeat the user's selections at any time. Each wireless local area network 260 may be configured with its own protocol, or else all wireless local area networks 260 may use the same protocol. If they use different protocols, then configuration information may be transmitted from the wireless local area network 260 to the user's wireless handheld device 202 when communication is initially established.

When the user has made all desired selections and indicated that all such selections are complete, the wireless local area network 260 then forwards the information to the point-of-sale system 261 for processing by the store clerks. For example, if the wireless local area network 260 is a fast food establishment, the store clerks may begin to prepare the user's order. At this point the user may also attempt to purchase the goods using a remotely accessible account. The actual purchase may be conducted in any of a variety of manners. For example, the purchase may be conducted as a traditional monetary transaction using conventional currency, a credit or debit account, or else may be conducted electronically by drawing upon a user account managed at least in part by the remote processing center 240.

If the user so desires, the user may enter a specific command indicating the user's desire to utilize the remotely accessible account. The wireless local area network 260 receives the user's selection and preferably obtains one or more of the user's telephone number, mobile equipment identification number, personal ID number, and password, and conveys any combination of these to the remote processing center 240 for further processing. The remote processing center 240 provides the necessary authentication and validation, and returns an acceptance or denial indication. If the transaction is accepted, then the local computer 266 forwards the information to the POS system 261. The acceptance may be forwarded with some type of user-identification information, such as the last four digits of the user's telephone number, so that the store clerks can associate the accepted transaction with the appropriate user. Alternatively, the store clerk may use the wireless local area network 260 to contact the user, by selecting a command (if provided) which causes the wireless local area network 260 to page the user's wireless handheld device 202 when the order is ready for pick up.

Besides fast food restaurants, the wireless techniques described herein may apply to a wide variety of other contexts and applications as well. For example, the wireless technology may be used to order and pay for movie or concert tickets from a nearby theater; to order and pay for coffee, beverages, or other convenience items from nearby kiosks or retail establishments; to order and pay for food at sit-down restaurants or other food establishments; to purchase gasoline at a gas station; to purchase transit tickets on a bus or transit vehicle (an example of which is described in more detail later herein); or to order and purchase any type of retail goods or services. In each case, the user can use his or her wireless handheld device 202 to pay for goods, without needing to use conventional currency or a separate credit or debit card. Moreover, the wireless handheld device 202 can display not only menus but also pictures of product, if such display capability is supported by the wireless handheld device 202.

As yet another application of the wireless techniques described above, the wireless local area network 260 may be used for servicing reservations at, for example, a restaurant. When a user enters the range of the microcell 250 associated with the wireless local area network 260, the user's wireless handheld device 202 is automatically prompted by the wireless local area network 260 according to the techniques previously described herein. The user may be prompted to enter a request for a reservation and the local restaurant (or other establishment) and a desired reservation time, using the keypad or other interface mechanism of the wireless handheld device 202. The wireless local area network 260 then receives and records the user's desired reservation time. If the reservation time is not available, the user may be so notified and asked to select a different time. When the appointed time has arrived or the user's table is ready, the wireless local area network 260 may automatically page the user's wireless handheld device 202. The user may therefore be free to roam anyplace within microcell 250 while waiting for the reserved table. A restaurant using this approach need not hand out special pagers to customers, but instead can rely on the customers' own wireless devices, thus reducing the risk that the specialized pagers are lost or stolen. Nonetheless, the restaurant may also intermix the techniques by giving specialized pagers to customers lacking a wireless handheld device. In such a case, the specialized pagers preferably are configured to communicate with the wireless local area network 260.

According to certain embodiments, a user may be able to increase periodically the amount of funds available for use at point-of-sale systems. Users may be allowed, for example, to increase the amount of funds available through an online interface which allows interaction with the remote processing center 240. Funds may be transferred in such a manner using any suitable means, including through a credit card transaction, transfer from an e-purse or user financial account, or by any other means. Alternatively, the user may conduct a transaction via telephone, at a point-of-sale kiosk, or at an automated banking machine, to transfer funds from one user account to the user's remote processing center account.

According to one embodiment, the user may request an increase in funds available in the user's remote processing center account using his or her wireless handheld device 202. The user may dial a special telephone number, and then can enter the amount of funds to be transferred using the interface (e.g., keypad) of the wireless handheld device 202. The user may be required to enter an identification number and/or password for verification. The cellular network 220 and/or remote processing center 240 may also use the mobile equipment identifier of the wireless handheld device 202 for verification.

In certain embodiments, multiple wireless local area networks 260 (i.e., POS systems) will co-exist in the same geographical region, with their associated microcells 250 overlapping to varying degrees. Multiple POS systems in the same geographical area may increase the complexity of the overall system and, in particular, the initial handshaking carried out by the user's wireless handheld device 202.

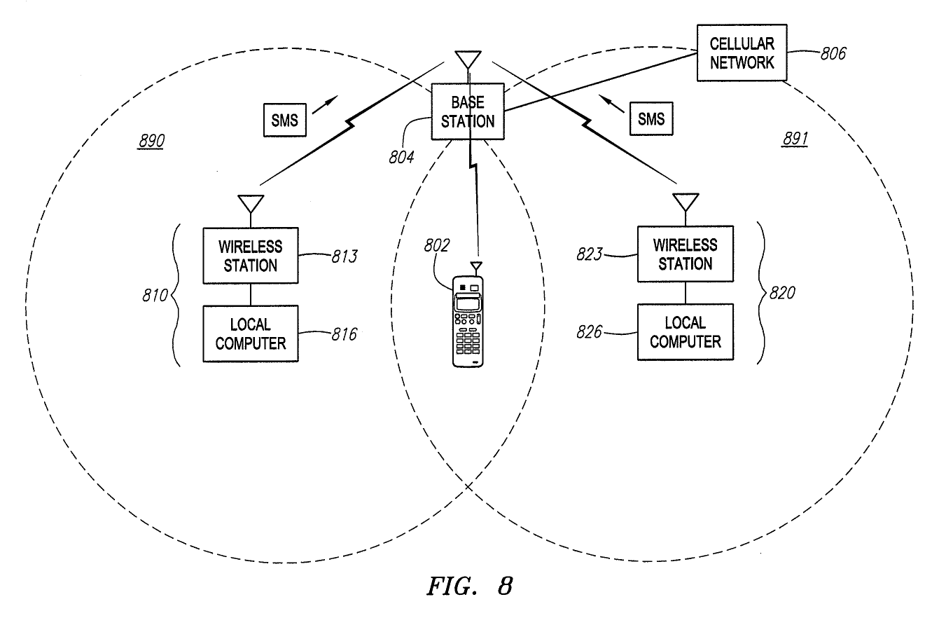

An example of operation of a system in which multiple point-of-sale systems co-exist in the same geographical region is illustrated in FIG. 8. As shown therein, a first wireless local area network 810 associated with a first point-of-sale system communicates within a microcell 890, while a second wireless local area network 820 associated with a second point-of-sale system communicates within a different microcell 891 overlapping at least in part with the first microcell 890. It is possible in this situation that a user may enter a region in which the first microcell 890 and second microcell 891 overlap. In this situation, each of the wireless local area networks 810, 820 may detect the presence of the user's wireless handheld device 802 according to any of the techniques previously described or referenced herein. For example, the wireless equipment 813 or 823 at the wireless local area networks 810, 820 may detect periodic re-registration or other sporadic communications between the wireless handheld device 802 and a local cellular base station 804. Alternatively, the cellular network 806 may be configured to notify the wireless local area networks 810, 820 that the particular wireless handheld device 802 is within the cell of the base station 804, and the wireless equipment 813 and 823 of the wireless local area networks 810, 820 may attempt to page the wireless handheld device 802 periodically. The base station 804 may notify the wireless handheld device 802 to listen to a particular paging frequency or channel utilized by the wireless equipment 813 or 823 of the wireless local area networks 810, 820, or else, for example, the wireless equipment 813 or 823 may communicate with the wireless handheld device 802 using the base station 804 as an intermediary. In the latter situation, the wireless equipment 813 or 823 may use short messages (e.g., SMS type messages) for communication with the wireless handheld device 802.

If the wireless equipment 813 or 823 is using SMS or similar messages via the base station 804 to communicate with the user's wireless handheld device 802, then the wireless handheld device 802 will generally receive several SMS or similar messages in a relatively short time period. The user may, for example, scroll through the SMS or similar messages and select a response thereto. The response can be handled in any of a variety of different ways. For example, a “time echo” approach may be used, wherein the user's wireless handheld device 802 responds in an assigned time slot when user hits “select,” with different time slots being used by the base station 804 to distinguish communications intended for the different wireless local area networks 810, 820. The base station 804 thereby knows where to route each reply message. The wireless handheld device 802 may temporarily save the received messages and allow the user to manually scroll through them using, e.g., buttons or voice commands. Alternatively, the wireless handheld device 802 may be programmed to display each received message for a brief period (e.g., three seconds), and to respond with a negative reply to the requesting point-of-sale system if the user does not make a positive selection. The wireless handheld device 802 may, if desired, be configured with other programming and features to facilitate navigation through the received messages and selection by the user.

If the user replies with a negative response to a given point-of-sale system, then the wireless local area network 810 or 820 will not re-page the user's wireless handheld device 802 for a certain backoff period (which may be programmable or otherwise selectable at each point-of-sale system). If there are other point-of-sale systems in the area, or if the user continues to move and thereby enter the range of a new point-of-sale system, the user's wireless handheld device 802 may still receive pages from the other point-of-sale systems.

If instead of using the base station 804 as an intermediary for communication with the wireless handheld device 802, the wireless equipment 813 or 823 contacts the wireless handheld device 802 over a special frequency or channel associated with the respective wireless local area network(s) 810 or 820, then the initial selection process by the user may be somewhat different. For example, it may be desirable to have the wireless local area networks 810, 820 share the same special frequency or channel through which the initial communication setup may be provided. Any number of point-of-sale systems in the same geographical proximity may share the same special frequency or channel, which simplifies the activity of the base station 804. Each wireless local area network 810, 820 may be assigned a logical sub-channel (e.g., time slot) of the special frequency or channel, and may communicate information in its assigned sub-channel. The user's wireless handheld device 802, when monitoring the special frequency or channel, may thereby receive an indication of the different wireless local area networks 810, 820 within communication range.

Continuing with the present example, the wireless handheld device 802 may receive paging messages over the special frequency or channel prompting the user to initiate a transaction. Similar to the process described in the previous example, the user may scroll through each message and select in either the negative or affirmative. Each response may be transmitted in an assigned reply sub-channel or else may use the particular sub-channel allocated to the particular wireless local area network 810 or 820. As before, once the user has declined an invitation to proceed with a transaction, the wireless equipment 813 or 823, as appropriate, may backoff for a certain period during which the user will not be further paged.

According to one embodiment as disclosed herein, the wireless handheld device 802 recognizes when a page is from a point-of-sale system and is configured or programmed to use a different ring tone than when receiving pages or calls from other sources. Also, or in addition, each point-of-sale system can have a special ring tone, and the ring tone information (or ring tone selection information) may be transmitted in connection with the initial paging or similar message to the user's wireless handheld device 802. Alternatively, the user may program the wireless handheld device 802 to select particular ring tones for specific point-of-sale systems.

According to another embodiment, multiple point-of-sale establishments in a nearby geographic area share the same wireless equipment, but may have, for example, separate POS terminals and, if desired, separate software functions (e.g., accounting databases). This embodiment may be well suited for, e.g., a food court with a number of food establishments located in close proximity. Cost savings may be achieved by having the various food establishments share the same wireless equipment. Using the same wireless equipment also reduces the possibility of interference, and simplifies the handshaking process with the users' cellular telephones or other wireless handheld devices. The user may be presented with a menu of selection options for the various point-of-sale establishments in a given locality, and may make the selection using the wireless handheld device. Once the initial selection is made, the transaction may proceed largely as described before with respect to the single point-of-sale system.

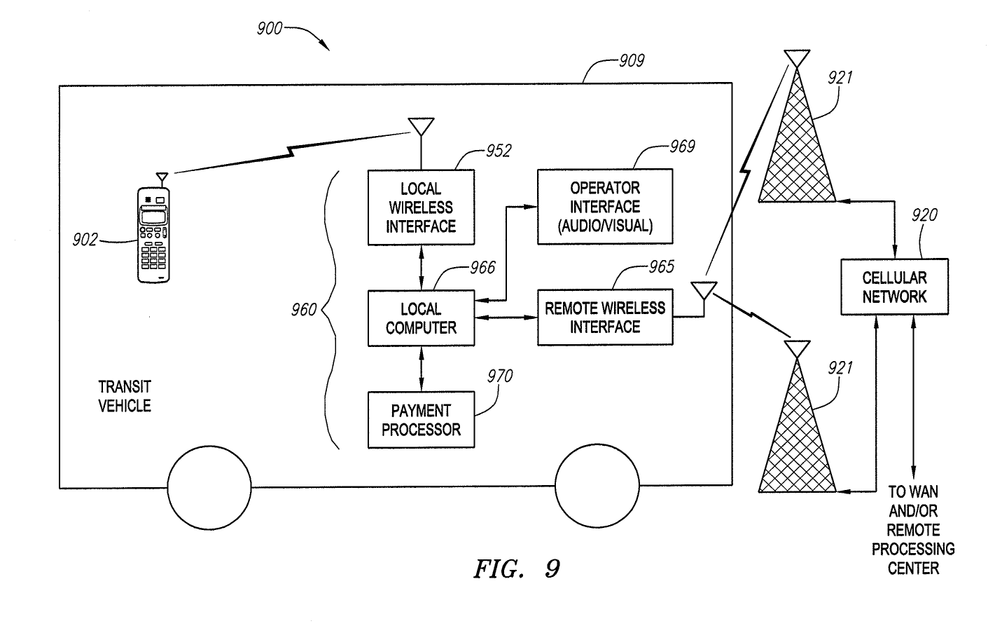

Another more detailed example will be provided in the context of purchasing transportation fare for a transit vehicle (which could be applicable to, e.g., bus, train, light rail, etc.). Such an example is illustrated in FIG. 9. In this example, the wireless transaction system 960 is adapted to reside in an electronic/computer system on-board the transit vehicle 909, and preferably has a wireless communication link available with an external station (via satellite, cellular network, dedicated wireless channels, or otherwise). In the instant example, a remote wireless interface 965 of the on-board wireless transaction system 960 communicates with a cellular network 920 via external stations 921 which are geographically dispersed. The on-board wireless transaction system 960 may communicate with a remote processing center (not shown in FIG. 9) directly via the cellular network 920, or else through a wide-area network (such as the Internet) via the cellular network 920 and a WAN gateway (also not shown in FIG. 9).

When a passenger boards the transit vehicle 909, the on-board wireless transaction system 960 senses the presence of the passenger's wireless handheld device 902 and provides an indication (e.g., audible tone and/or visual message or LED activation) so that, for example, the operator of the transit vehicle 909 is made aware that the passenger will be purchasing a fare using the automated system. The on-board wireless transaction system 960 may detect periodic transmissions by the user's wireless handheld device 902, or else may physically detect the presence of the wireless handheld device 902 through a detector (not shown in FIG. 9) if the wireless handheld device 902, for example, is outfitted with an RFID tag, bar code, or other means for physical identification.

Once on board, the passenger preferably keeps the wireless handheld device 902 active while being transported on the transit vehicle 909. The situation where the passenger turns off the wireless handheld device 902 may be handled in different ways; for example, the passenger may be charged an agreed-upon fee in such a case. In a preferred embodiment, the ultimate charge is based on the distance the passenger travels. When the passenger exits the transit vehicle 909, the passenger leaves the range of the on-board wireless transaction system 960. Once the on-board wireless transaction system 960 no longer detects the presence of the passenger's wireless handheld device 902, it either records a charge to be applied to the passenger's account associated with the wireless handheld device 902, and/or transmits a message to the remote processing center, via external wireless station 921, for processing. The on-board wireless transaction system 960 may calculate and send the amount of the transit fare charge to the remote processing center via external station 921, or else may simply send information indicating the amount of travel time by the passenger, allowing the automated system associated with the remote processing center to perform the calculation for the fare.

The system 900 illustrated in and described with respect to FIG. 9 can utilize the same or similar system components as described earlier with respect to the other Figures disclosed herewith. The on-board wireless transaction system 960 may interface with the passenger's wireless handheld device 902 in a similar manner to previously described, and may communicate with a remote processing center (not shown in FIG. 9) in a manner as previously described with respect to the other embodiments described herein, in order to carry out a transaction for the purchase of a transit fare.

The on-board wireless transaction system 960 may also provide information such as route, schedule, etc. which may be displayed on the user's wireless handheld device 902. The information may be displayed either as text or, if supported by the wireless handheld device 902, graphics. The on-board wireless transaction system 960 may have route, schedule and other such information stored locally at the local computer 966, or else may receive such information from a remote source via the remote wireless interface 965.

One possible advantage of the system in FIG. 9, and other embodiments as described herein, is that a consumer (e.g., a passenger in the FIG. 9 system) can utilize his or her own cellular telephone or other wireless communication device to carry out various consumer transactions. Since most individuals already own and use cellular telephones or similar devices, the disclosed systems and techniques enhance consumer convenience. The disclosed systems and techniques therefore allow an individual's cellular telephone or other wireless communication device to become multi-functional and, in particular, to be used in a manner similar to credit or debit cards, while also providing wireless communication for voice and/or data, depending upon the nature of the wireless communication device. Of course, it is not essential for a wireless communication device used in any of the various embodiments disclosed herein to provide separate functionality apart from the consumer transaction capabilities disclosed herein.

As used herein, a “cell” in the context of a cellular network may be any geographical region serviced by cellular provider equipment, and may, for example, comprise a UMTS macrocell, microcell, or even a picocell, depending upon circumstances. A “microcell” as used in context of wireless station or wireless local area network does not necessarily mean the same thing as a UMTS microcell. Rather, a microcell generally includes, for example, a cellular area in which a potential consumer having a wireless handheld device may be present and proximate to a point-of-sale location. Generally a microcell will be smaller than a normal sized cell of a cellular network; for example, a microcell in a typical application may be approximately 100 to 200 yards in radius.

According to various embodiments as disclosed herein, a system architecture and associated methods are provided whereby consumers may set up and carry out point-of-sale transactions in an automated or semi-automated manner, using a wireless handheld device. In certain preferred embodiments, a microcellular, short range transceiver associated with a point-of-sale system and wireless local area network operates in parallel with an external network providing cellular coverage. Preferably, operation of the wireless equipment within the cell of the cellular system provides no or minimal interference with the normal external communications of cellular users over the cellular network. To this end, the bandwidth or channels within a given cell may be divided between the cellular base station(s) and the wireless equipment of the point-of-sale system(s). The base station may assign a given bandwidth or channels to the wireless equipment of the point-of-sale system(s) on an ad hoc or semi-permanent basis. Alternatively, communications may be conducted using the local cellular base station as an intermediary, so that the wireless equipment does not interfere with the normal communications of cellular users. Rather, the wireless equipment of the point-of-sale systems is generally treated like any other cellular user.

The wireless equipment (e.g., transceiver) of the point-of-sale system is preferably electrically connected to a point-of-sale computer, which is in turn coupled (via, e.g., the Internet, a WAN, or a dedicated connection) to a remote processing center. The point-of-sale system is preferably configured to allow the user to set up a point-of-sale transaction in an automated fashion using a wireless handheld device (e.g., cellular telephone), and to facilitate actual purchase of the desired goods or services through an electronic transaction involving the remote processing center.

A number of embodiments have been described in connection with a wireless handheld device 202. However, it should be understood that the wireless handheld device 202 need not be a standalone device but may, for example, be integrated with other electronics, or a vehicle.

While preferred embodiments of the invention have been described herein, many variations are possible which remain within the concept and scope of the invention. Such variations would become clear to one of ordinary skill in the art after inspection of the specification and the drawings. The invention therefore is not to be restricted except within the spirit and scope of any appended claims.

What is claimed is:

1. A wireless consumer transaction system for carrying out consumer transactions at a point-of-sale establishment, comprising:
a wireless station affiliated with a point-of sale system, said wireless station configured to automatically detect the presence of a wireless handheld device within a microcellular region, and to convey a menu of user options to the wireless handheld device;
a local computer configured to convey, via the wireless station, a menu of user options to the wireless handheld device, to receive, via the wireless station, responsive user selections from the wireless handheld device, and to determine a point-of-sale transaction price based upon said user selections;
a network interface for communicating with a remote processing center to obtain approval for a point-of-sale transaction; and
a point-of-sale terminal communicatively coupled to said computer, said point-of-sale terminal displaying an indication of whether the point-of-sale transaction was approved by the remote processing center.

2. The wireless communication system of claim 1, wherein said wireless station is configured to communicate according to a plurality of different cellular protocols.

3. The wireless communication system of claim 1, wherein detection of said wireless cellular device by said wireless station triggers said wireless station to initiate an exchange of point-of-sale information with said wireless cellular device.

4. The wireless communication system of claim 1, wherein said remote processing center automatically accesses a remote user account associated with the wireless cellular device in response to receiving the request for approval of a point-of-sale transaction.

5. The wireless communication system of claim 4, wherein said remote processing center automatically deducts an amount of funds from said remote user account sufficient to cover the transaction price of the point-of-sale transaction.

6. The wireless communication system of claim 5, wherein said remote processing center authenticates the user or wireless cellular device before approving the point-of-sale transaction.

7. The wireless communication system of claim 6, wherein said remote processing center uses a mobile equipment identifier associated with the wireless cellular device in connection with authentication.

8. The wireless communication system of claim 6, wherein said remote processing center uses a password entered by the user via said wireless cellular device in connection with authentication.

9. The wireless communication system of claim 1, wherein said wireless handheld device comprises a cellular telephone.

10. A method for facilitating consumer transactions at a point-of-sale system affiliated with a point-of-sale establishment, the method comprising the steps of:
automatically detecting, at a wireless station associated with the point-of-sale system, the presence of the wireless handheld device;
automatically establishing communication between the wireless station and the wireless handheld device;
transmitting, via the wireless station, a menu of options for presentation on a display portion of the wireless handheld device;
receiving from the wireless handheld device, via the wireless station, one or more responsive user selections;
determining a transaction price based upon the user selections;
triggering an automated transaction with a remote processing center, whereby funds in a user account associated with the remote processing center are utilized to purchase the user selections at the point-of-sale establishment;
automatically receiving, at the point-of-sale system, a point-of-sale transaction approval message from the remote processing center;
displaying an indication of the point-of-sale transaction approval at a point-of-sale terminal; and
durably storing a record of the point-of-sale transaction for later access.

11. The method of claim 10, wherein said user account is accessible through any of a plurality of point-of-sale systems, said user account being available for funding purchases at any of the point-of-sale systems.

12. The method of claim 10, wherein said wireless station is configured to obtain, via the wireless station, a user password and/or mobile equipment identifier associated with the wireless handheld device, for authentication by the remote processing center.

13. The method of claim 10, wherein the user options comprise a list of food items available for purchase at the point-of-sale establishment.

14. The method of claim 10, wherein said step of automatically detecting the presence of the wireless handheld device comprises automatically detecting, at said wireless station, activity of the wireless handheld device in communicating with a separate cellular network.

15. The method of claim 10, further comprising the steps of
transmitting a transaction initiation request via the wireless station prompting the user to initiate a point-of-sale transaction;
receiving a user-entered response from the wireless handheld device via the wireless station; and
performing the step of transmitting said menu of options to the wireless handheld device in response thereto.

16. The method of claim 15, wherein said transaction initiation request identifies the point-of-sale establishment.

17. The method of claim 16, wherein said transaction initiation request further identifies a geographic location of the point-of-sale establishment.

18. The method of claim 10, wherein said user account is accessible through any of a plurality of point-of-sale systems, each of said point-of-sale systems configured to automatically detect the transient presence of the wireless handheld device, the method further comprising the steps of:
transmitting a plurality of transaction initiation requests to the wireless handheld device, each of said transaction initiation requests transmitted by a point-of-sale system when the wireless handheld device is detected by the point-of-sale system, and each of said transaction initiation requests prompting the user to initiate a point-of-sale transaction; and
receiving a user-entered response from the wireless handheld device at one of the point-of-sale systems;
wherein the wireless handheld device is configured to allow the user thereof to scroll among the different transaction initiation requests.

19. The method of claim 18, wherein each of said transaction initiation requests identifies its associated point-of-sale establishment.

20. The method of claim 19, wherein one or more of said transaction initiation requests further identifies a geographic location of its associated point-of-sale establishment.
